(19) United States
(12) Patent Application Publication
(10) Pub. No.: US 2020/0039402 A1
(43) Pub. Date: Feb. 6, 2020

(54) TOWEL FOR COVERING A CAR SEAT

(71) Applicant: Michele Daniela Barker, Capistrano Beach, CA (US)

(72) Inventor: Michele Daniela Barker, Capistrano Beach, CA (US)

(21) Appl. No.: 16/524,582

(22) Filed: Jul. 29, 2019

Related U.S. Application Data
(60) Provisional application No. 62/712,751, filed on Jul. 31, 2018.

(51) Int. Cl. B60N 2/60; A47K 10/12

(52) U.S. Cl. CPC B60N 2/6036; A47K 10/12

(57) ABSTRACT

A car seat cover includes a cloth material having a top end, a bottom end, a first side, and a second side. A pouch is disposed at the top end of the cloth material. The pouch is configured to fit over a head rest of a car seat. A first connector is coupled to the first side at the top end and a second connector is coupled to the second side at the top end. The first connector releasably connects to the second connector.

### CROSS-REFERENCE TO RELATED APPLICATION

This application claims the benefit of priority of U.S. provisional application No. 62/712,751, filed Jul. 31, 2018, the contents of which are herein incorporated by reference.

### BACKGROUND OF THE INVENTION

The present invention relates to protecting a car seat and, more particularly, to a towel for covering a car seat.

After a day at the beach, beachgoers are typically wet and covered in sand and sunscreen. Currently, car seat covers may be used to protect a car sear from getting dirty. However, car seat covers are not designed to easily be removed from the car for washing and are also not for use outside the car. Thus, most seat covers remain dirty in the car. Towels may be used to cover the car seats. However, towels do not work well as a car seat cover as they slip and fall off the seat.

As can be seen, there is a need for an improved towel that secures to a car seat.

### SUMMARY OF THE INVENTION

In one aspect of the present invention, a car seat cover comprises: a cloth material comprising a top end, a bottom end, a first side, and a second side, wherein a pouch is disposed at the top end of the cloth material, the pouch configured to fit over a head rest of a car seat; and a first connector coupled to the first side at the top end and a second connector coupled to the second side at the top end, wherein the first connector releasably connects to the second connector.

In another aspect of the present invention, a method of protecting a car seat of a vehicle comprises steps of: providing a car seat cover comprising: a cloth material comprising a top end, a bottom end, a first side, and a second side, wherein a pouch is disposed at the top end of the cloth material; and a first connector coupled to the first side at the top end and a second connector coupled to the second side at the top end; placing the cloth material over a top surface of a car seat; placing the pouch over a head rest of the car seat so that the head rest is disposed within the pouch; and releasably connecting the first connector to the second connector behind the car seat head rest.

These and other features, aspects and advantages of the present invention will become better understood with reference to the following drawings, description and claims.

### BRIEF DESCRIPTION OF THE DRAWINGS

FIG. 1 is a side view of an embodiment of the present invention in use;

FIG. 2 is a top plan view of an embodiment of the present invention;

FIG. 3 is a detail to plan view indicated by line 3-3 in FIG. 2;

FIG. 4 is a rear perspective view of an embodiment of the present invention; and

FIG. 5 is a detail rear perspective view of an embodiment of the present invention in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes an automobile seat cover designed to also be used as a beach towel. The present invention combines a beach towel and car seat cover to create a design that is easy to use, wash and install.

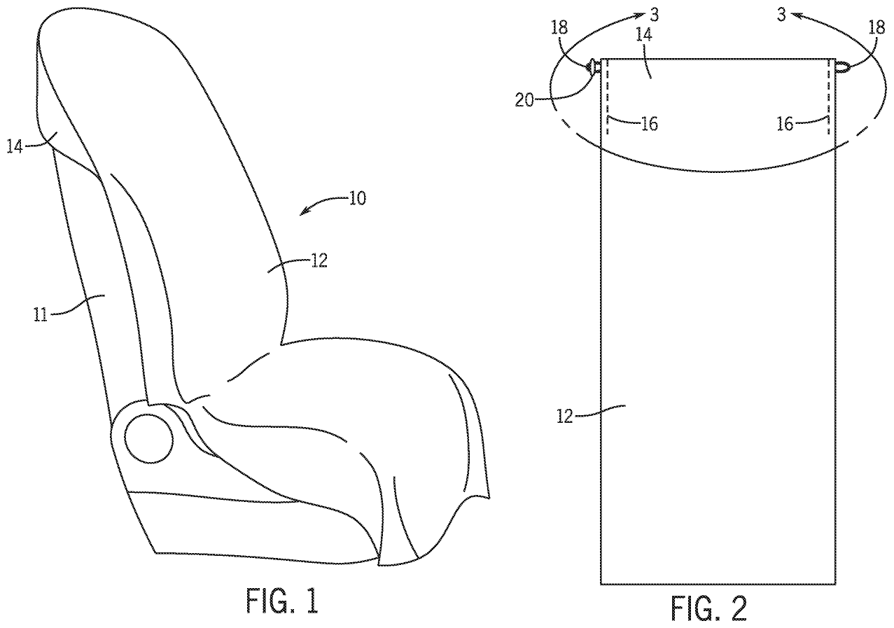

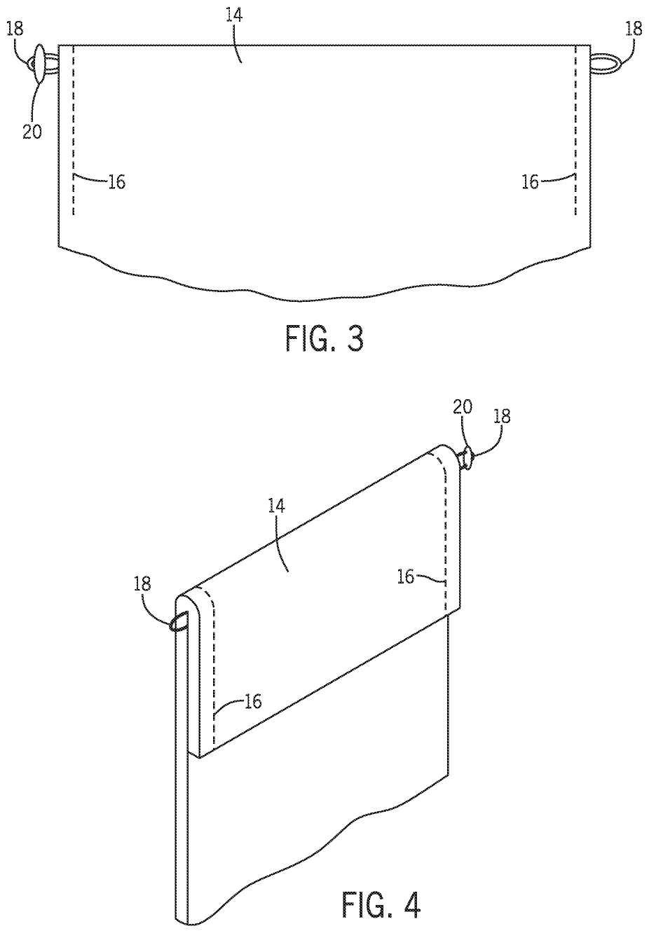

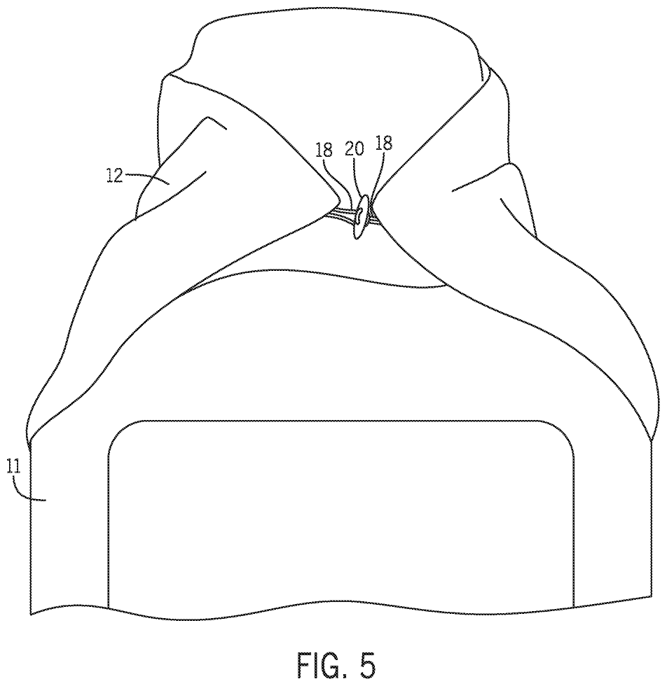

Referring to FIGS. 1 through 5, the present invention includes a car seat cover 10. The car seat cover 10 includes a cloth material 12 having a top end, a bottom end, a first side, and a second side. A pouch 14 is disposed at the top end of the cloth material 12. The pouch 14 is configured to fit over a head rest of a car seat 11. A first connector 18, 20 is coupled to the first side at the top end and a second connector 18, 20 is coupled to the second side at the top end. The first connector 18, 20 releasably connects to the second connector 18, 20.

The cloth material 12 is a towel that may be made of a cotton, polyester or combination thereof. The cloth material 12 may be made of an absorbent layer to adsorb liquid and a non-absorbent layer to protect the car seat 11. The cloth material 12 may be an elongated rectangular shape. The top end is folded over, the first side is stitched to itself by stitching 16, and the second side is stitched to itself by stitching 16, forming the pouch 14. An opening is formed in between an edge of the cloth material 12 and the body of the cloth material 12, defining an entrance into the pouch 14.

In certain embodiments, the first connector 18, 20 is a looped cord 18 and the second connector 18, 20 a toggle button 20 coupled to a looped cord 18. The toggle button 20 of the second connector 18, 20 fits within the looped cord 18 of the first connector 18, 20, releasably connecting the first connector 18, 20 to the second connector 18, 20. The looped cords 18 may be made of a stretchable, elastic, and resilient material. Therefore, the looped cords 18 may be stretched to attach the toggle button 20, securely retaining the pouch 14 to the head rest of the car seat 11. The connectors 18, 20 may alternatively include snap buttons, hook and loop fasteners, buckles, ties, and the like.

A method of protecting a car seat of a vehicle may include the following steps: provide the car seat cover 10 described above; placing the cloth material 12 over a top surface of a car seat 11; placing the pouch 14 over a head rest of the car seat 11 so that the head rest is disposed within the pouch 14; and releasably connecting the first connector 18, 20 to the second connector 18, 20 behind the car seat head rest. The first connector 18, 20 may be connected to the second connector 18, 20 by pulling the toggle button 20 towards the looped cord 18 and inserting the toggle button 20 into the looped cord 18.

It should be understood, of course, that the foregoing relates to exemplary embodiments of the invention and that modifications may be made without departing from the spirit and scope of the invention as set forth in the following claims.

What is claimed is:

1. A car seat cover comprising:
a cloth material comprising a top end, a bottom end, a first side, and a second side, wherein a pouch is disposed at the top end of the cloth material, the pouch configured to fit over a head rest of a car seat; and
a first connector coupled to the first side at the top end and a second connector coupled to the second side at the top end, wherein the first connector releasably connects to the second connector.

2. The car seat cover of claim 1, wherein the cloth material is an elongated rectangular shape.

3. The car seat cover of claim 1, wherein the top end is folded over, the first side is stitched to itself, and the second side is stitched to itself, forming the pouch.

4. The car seat cover of claim 1, wherein the first connector comprises a looped cord and the second connector comprises a toggle button coupled to a cord, wherein the toggle button fits within the looped cord, releasably connecting the first connector to the second connector.

5. The car seat of claim 4, wherein the looped cord and the cord are made of a stretchable, elastic, and resilient material.

6. A method of protecting a car seat of a vehicle comprising steps of:
providing a car seat cover comprising:
a cloth material comprising a top end, a bottom end, a first side, and a second side, wherein a pouch is disposed at the top end of the cloth material; and
a first connector coupled to the first side at the top end and a second connector coupled to the second side at the top end;
placing the cloth material over a top surface of a car seat;
placing the pouch over a head rest of the car seat so that the head rest is disposed within the pouch; and
releasably connecting the first connector to the second connector behind the head rest.

7. The method of claim 6, wherein the cloth material is an elongated rectangular shape.

8. The method of claim 6, wherein the top end is folded over, the first side is stitched to itself, and the second side is stitched to itself, forming the pouch.

9. The method of claim 6, wherein the first connector comprises a looped cord and the second connector comprises a toggle button coupled to a cord, wherein the toggle button fits within the looped cord, releasably connecting the first connector to the second connector.

10. The method of claim 9, wherein the looped cord and the cord are made of a stretchable, elastic, and resilient material.
